(19) United States
(12) Patent Application Publication
(10) Pub. No.: US 2026/0328172 A1
(43) Pub. Date: Oct. 22, 2026

(54) FUEL PUMP FOR THE DIRECT-INJECTION OF FUEL FOR INTERNAL COMBUSTION ENGINES

(71) Applicant: PHINIA DELPHI LUXEMBOURG SARL, Belvaux (LU)

(72) Inventors: Richard DUPONT, Tours (FR); Christophe BRÉANT, La Chapelle St Mesmin (FR)

(21) Appl. No.: 18/994,958

(22) PCT Filed: Jul. 14, 2023
(86) PCT No.: PCT/EP2023/069661

§ 371 Date: Jan. 15, 2025

(30) Foreign Application Priority Data
Jul. 15, 2022 (FR) 2207290

(51) Int. Cl. F02M 59/02; F04B 53/22

(52) U.S. Cl. CPC F02M 59/025; F04B 53/22

(57) ABSTRACT

A fuel pump for direct fuel injection for internal combustion engines comprises a pump body, a pumping chamber in which a piston is slidingly fitted, a spring bearing on the one hand on the pump body and on the other hand at one end of the piston protruding out of the pump body via a retaining washer and joining means between the retaining washer and the end of the piston. The joining means comprise a plurality of fingers originating from a ring of the retaining washer and arranged to as to protrude towards a central axis of the ring, one end of the fingers being accommodated in a circular groove of the piston and being held by the spring so as to bear against a shoulder delimiting the circular groove.

### FIELD OF THE INVENTION

The invention relates a fuel pump for direct fuel injection for internal combustion engines.

### BACKGROUND OF THE INVENTION

Fuel systems in modern, petrol-fuelled internal combustion engines, in particular those for the automotive market, use direct petrol injection, with the fuel injectors being used to inject the fuel directly into the engine's combustion chambers. In such direct-injection systems, the fuel coming from the tank is supplied by a low-pressure fuel pump incorporated into the tank. This low-pressure pump is generally electric and feeds a high-pressure pump which typically comprises a pump piston which is mobile within a pump body. The pump piston is actuated by a camshaft of the internal combustion engine so as to raise the fuel pressure fuel in a pumping chamber of the pump body. The fuel under high pressure is then distributed to the injectors which control injection of the fuel directly into the engine's combustion chamber.

Document EP 3 715 619 A1 discloses an example of a pump of this type. An example is also reproduced in FIG. 1. The movement of the piston 101 in the pumping chamber 1050 is provided by the camshaft 102 against a spring 103 which tends to hold one end of piston 101 bearing against one cam of the camshaft 102. The spring is of the helicoidal compression type and bears on the one hand on a seat 104 fixed to the body 105 of the pump and on the other hand on a retaining washer 106 joined to the end of the piston 101 by joining means 107. The joining means comprise two conical half-rings 1071 engaged with an indentation 1072 at the end of the piston and a conical receptacle 1073 borne by the retaining washer 106 in which the conical half-rings 1071 are accommodated. The gradient of the cone of the receptacle 1073 is oriented in such a manner that the action of the spring 103 on the retaining washer 106 is blocked by the conical half-rings 1071 wedged in the receptacle 1073.

Although these retaining means are effective, they have a number of drawbacks. It will in effect be noted that assembly operations are complex. This is because it is necessary to place the spring and the retaining washer around piston, then compress the spring in order to free up enough space to introduce the conical half-rings. Compression of the spring can then be released, so that the retaining washer moves to trap the conical half-rings. It will likewise be noted that it may happen that just a single half-ring is set in place and that this fault may only be belatedly detected, leading to high intervention costs. Furthermore, the surfaces of the indentation, of the conical half-rings and of the receptacle are relatively precisely machined surfaces, resulting in high production costs.

### SUMMARY OF THE INVENTION

It is therefore an object of the invention to provide a fuel pump for direct fuel injection for internal combustion engines which is simple and reliable to construct and which minimises costs.

With these objects in mind, the invention relates to a fuel pump for direct fuel injection for internal combustion engines, the pump comprising a pump body, a pumping chamber in which a piston is slidingly fitted, a spring bearing on the one hand on the pump body and on the other hand at one end of the piston protruding out of the pump body via a retaining washer and joining means between the retaining washer and the end of the piston, the pump being characterised in that the joining means comprise a plurality of fingers originating from a ring of the retaining washer and arranged so as to protrude towards a central axis of the ring, one end of the fingers being accommodated in a circular groove of the piston and being held by the spring so as to bear against a shoulder delimiting the circular groove.

Thanks to the invention, no other part is needed for fixing the retaining washer. There is therefore no risk of a part being absent. With joining to the piston being achieved using fingers, i.e. separate elements, assembly is easy, with the retaining washer being introduced onto the piston and the fingers spreading apart until they arrive at the groove. Once there, the ends of the fingers are accommodated in the groove, so locking the retaining washer in place. Assembling in this way is straightforward and reliable and the retaining washer may be obtained by inexpensive cutting out and pressing operations.

According to one advantageous feature, the ends of the fingers are flexibly mobile relative to the ring. Recovery of the ends of the fingers on reaching the circular groove during introduction of the retaining washer onto the piston occurs spontaneously.

According to one improvement, the fingers are inclined relative to a plane perpendicular to the central axis, being oriented to produce a buttress against the piston in the circular groove when the spring bears on the retaining washer. In this way, the more the retaining washer is subjected to a force tending to extract it from the piston, the more the ends of the fingers are pressed into the groove. The fingers distributed all around the groove counterbalance one another. The retaining force which is thus obtained is very strong.

In particular, the inclination of the fingers is between 15 and 35° and preferably between 20° and 30°.

According to one constructional arrangement, the diameter of the bottom of the groove is less than the end diameter of the piston by a value of between 2 and 10% and preferably between 4 and 5% of the end diameter. It is thus ensured that the depth of the groove is sufficient to retain the retaining washer, without the piston being weakened excessively.

According to other arrangements:
the retaining washer comprises a guide crown extending according to the central axis of the ring along the spring to centre the spring on the retaining washer, so ensuring that the spring is well centred on the retaining washer;
the retaining washer comprises an annular-shaped flange joined to the crown for receiving the spring;
the ring is joined to the crown;
the piston comprises a collar intended to come to bear against the pump body and limit the stroke of the piston when the retaining washer is engaged on the piston; The piston may already be in abutment against the bottom of the pumping chamber, but sometimes the latter is too deep to be able to introduce the retaining washer onto the piston. By providing a collar, the abutment position of the piston is determined independently;
the pump comprises a seat receiving the spring and bearing on the pump body, the seat comprising a sleeve on which the spring is centred and which surrounds the piston.

The invention also provides a method of assembling a pump as defined above, according to which the piston is introduced into the chamber, the spring is placed around the piston, the retaining washer is placed on the spring, and pressure is applied to the retaining washer to compress the spring until the fingers spread apart against the piston and then recover to enter the circular groove. This method is simpler than that of the prior art.

### BRIEF DESCRIPTION OF THE FIGURES

The invention will be better understood and other peculiarities and advantages will become apparent on reading the following description, the description, making reference to the appended drawings, in which:

FIG. 1 is a detail sectional view of a pump according to the prior art;

FIG. 2 is a view similar to FIG. 1 during a pump assembly phase according to one embodiment of the invention;

FIG. 3 is a view similar to FIG. 2, after assembly of the pump;

FIG. 4 is sectional, perspective view of the end of a piston and a retaining washer of the pump of FIG. 3;

FIG. 5 is a perspective view of the retaining washer of FIG. 4;

FIG. 6 is a view in longitudinal section of the retaining washer of FIG. 5.

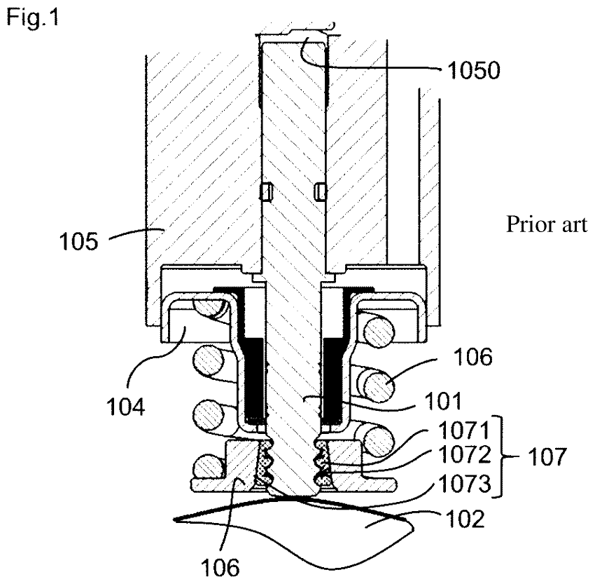

### DETAILED DESCRIPTION

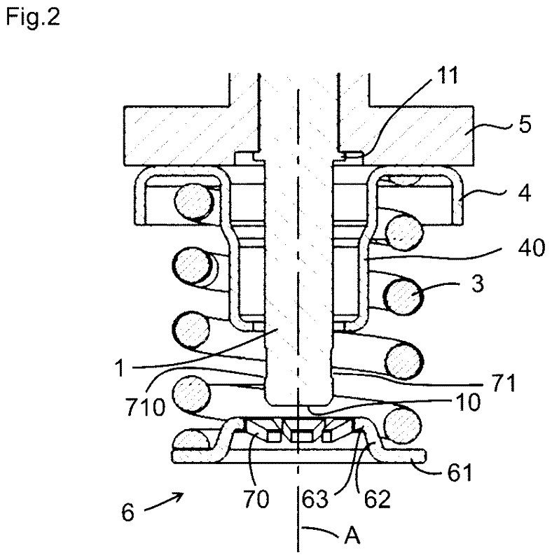

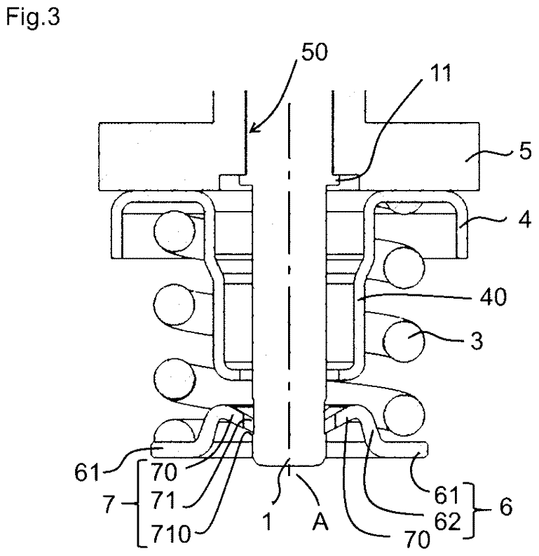

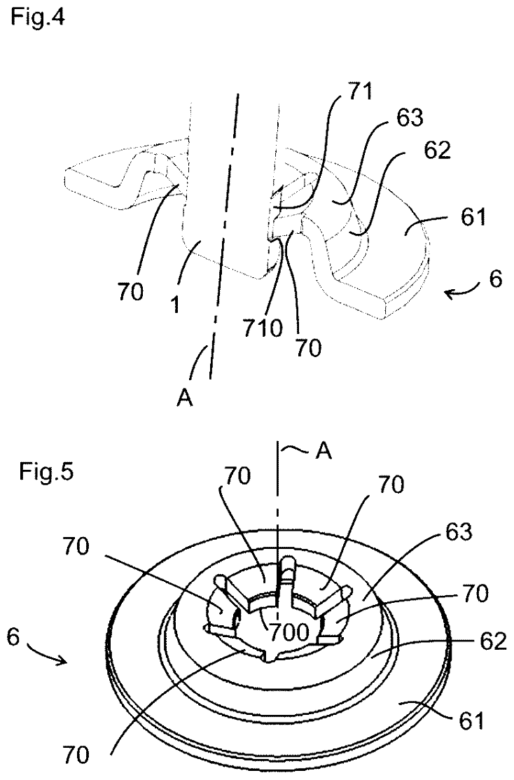

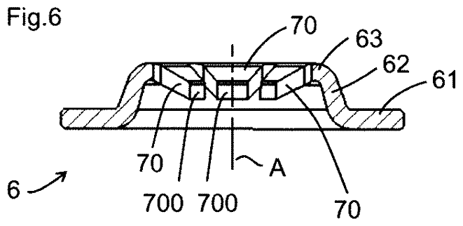

FIGS. 2 to 6 show a fuel pump for direct fuel injection for internal combustion engines according to one embodiment of the invention. The pump comprises a pump body 5, a pumping chamber 50 in which a piston 1 is slidingly fitted, a spring 3 bearing on the one hand on the pump body 5 via a seat 4 and on the other hand at one end 10 of the piston 1 protruding out of the pump body 5 via a retaining washer 6. The retaining washer 6 comprises an annular-shaped flange 61 having a central axis A for receiving the spring 3. The retaining washer 6 further comprises a guide crown 62 likewise having as its axis the central axis A and extending along the spring 3 from the flange 61 to centre the spring 3 on the retaining washer 6, and in particular on the flange 61. The guide crown 62 is substantially frustoconical in shape. The crown 62 is extended by a ring 63 also having as its axis the central axis A and extending in a plane which is raised relative to the plane of the flange 61.

Joining means 7 are provided between the retaining washer 6 and the end 10 of the piston 1. The joining means 7 comprise a plurality of fingers 70 originating from the ring 63 of the retaining washer 6 and arranged to protrude towards the central axis A, while being inclined with a base joined to the ring 63 closer to the pump body 5 than the ends 700 of the fingers 70 in contact with the piston 1. The ends 700 of the fingers 70 are accommodated in a circular groove 71 of the piston 1 and are held, by the spring 3 so as to bear against a shoulder 710 delimiting the circular groove 71. The ends 700 of the fingers 70 are flexibly mobile relative to the ring 63, as will be seen better in relation to the description of pump assembly. In other words, the fingers 70 are inclined relative to a plane perpendicular to the central axis A, being oriented to produce a buttress against the piston 1 in the circular groove 71 when the spring 3 bears on the retaining washer 6. The inclination of the fingers 70 is typically between 24 and 30°.

The diameter of the bottom 710 of the circular groove 71 is less than the end diameter of the piston 1 by a value of between 4 and 5% of the end diameter.

The piston 1 comprises a collar 11 intended to come to bear against the pump body 5 and limit the stroke of the piston 1 when the retaining washer 6 engages on the piston 1. The collar 11 could be replaced by a resilient ring inserted into a groove.

The seat 4 receiving the spring 3 bears against the pump body 5 and is fixed thereto. The seat 4 comprises a sleeve 40 on which the spring 3 is centred and which surrounds the piston 1. Optionally, stop means (not shown) may be accommodated between the body and the piston 1 in such a way as to limit the stroke of the piston 1 against the spring 3.

To assemble the pump, the piston 1 is introduced into the chamber with the collar 11 abutting against the pump body 5, the seat 4 is fixed on the body around the piston 1, the spring 3 is placed around the piston 1 so as to bear against the seat 4, the retaining washer 6 is placed on the spring 3, and pressure is applied to the retaining washer 6 to compress the spring 3. The fingers 70 then spread apart resiliently under the action of the end 10 of the piston 1 until they reach the circular groove 71. The resilient return movement of the fingers 70 pushes the ends thereof into the circular groove 71 until they bear against the bottom of the circular groove 71. The spring 3 can then be released, its action being taken up by the retaining washer 6, which comes to bear against the bottom of the circular groove 71 and the shoulder 710.

1. A fuel pump for direct fuel injection for internal combustion engines, the pump comprising a pump body, a pumping chamber in which a piston is slidingly fitted, a spring bearing on the one hand on the pump body and on the other hand at one end of the piston protruding out of the pump body via a retaining washer and joining means between the retaining washer and the end of the piston, wherein the joining means comprise a plurality of fingers originating from a ring of the retaining washer and arranged so as to protrude towards a central axis of the ring, one end of the fingers being accommodated in a circular groove of the piston and being held by the spring so as to bear against a shoulder delimiting the circular groove, the fingers being inclined relative to a plane perpendicular to the central axis, being oriented to produce a buttress against the piston in the circular groove when the spring bears on the retaining washer.

2. The pump according to claim 1, in which the ends of the fingers are flexibly mobile relative to the ring.

3. The pump according to claim 1, in which the inclination of the fingers is between 15 and 35°.

4. The pump according to claim 1, in which the diameter of the bottom of the groove is less than the end diameter of the piston by a value of between 2 and 10% of the end diameter.

5. The pump according to claim 1, in which the retaining washer comprises a guide crown extending according to the central axis of the ring along the spring to centre the spring on the retaining washer.

6. The pump according to claim 5, in which the retaining washer comprises an annular-shaped flange joined to the crown for receiving the spring.

7. The pump according to claim 5, in which the ring joined to the crown.

8. The pump according to claim 1, in which the piston comprises a collar intended to come to bear against the pump body and limit the stroke of the piston when the retaining washer engages on the piston.

9. The pump according to claim 1, further comprising a seat receiving the spring and bearing on the pump body, the seat comprising a sleeve on which the spring is centred and which surrounds the piston.

10. A method of assembling a pump according to claim 1, wherein the piston is introduced into the chamber, the spring is placed around the piston, the retaining washer is placed on the spring, and pressure is applied to the retaining washer to compress the spring until the fingers spread apart against the piston and then recover to enter the circular groove.
